(19) United States
(12) Patent Application Publication
(10) Pub. No.: US 2010/0186240 A1
(43) Pub. Date: Jul. 29, 2010

(54) Collapsible shield assembly for grass and wed trimmers

(76) Inventor: Dwayne L. Waugh, Maugansville, MD (US)

Correspondence Address: Donald A. Kettlestrings, Esquire;Suite 211, 414 Hungerford Drive, Rockville, MD, 20850, US

(21) Appl. No.: 12/321,702

(22) Filed: Jan. 26, 2009

(51) Int. Cl. B26B 29/00

(52) U.S. Cl. 30/286

(57) ABSTRACT

A collapsible protective shield assembly for grass and weed trimmers can be mounted on conventional grass and weed trimmers to keep debris from reaching the operator. When open, the shield assembly can be adjusted to enable the trimmer to get into hard to reach places. When not in use, the shield assembly can be collapsed into a compact configuration for easy storage. The shield assembly is mounted on the trimmer shaft a sufficient distance away from the trimmer cutting head to allow unobstructed operation of the trimmer.

### CROSS-REFERENCE TO RELATED APPLICATIONS

This application claims the benefit of U.S. provisional application No. 60/839,572, filed Aug. 24, 2006 and of PCT application no. PCT/US07/016386, filed Jul. 19, 2007.

### BACKGROUND OF THE INVENTION

This invention relates to grass and weed trimmers and more particularly to a collapsible protective shield assembly for grass and weed trimmers. The protective shield assembly can be adjusted to allow the trimmer to get into hard to reach places and the shield assembly can be collapsed into a compact configuration for easy storage.

Various types of grass and weed trimmer assemblies are known for protecting the operator from debris. Although such assemblies have served the purpose, they have not proved entirely satisfactory under all conditions of service because they have not enabled the trimmers to reach into and to be used in hard to reach or confined areas.

It is, therefore, an object of the present invention to provide a collapsible protective shield assembly for grass and weed trimmers.

Another object is to provide such a shield assembly which can be quickly and easily adjusted to enable the trimmers to be used in confined or hard to reach spaces.

Another object is to provide such an assembly which can be quickly and easily collapsed into a compact configuration for easy storage.

Additional objects and advantages of the invention will be set forth in part in the description which follows, and in part will be obvious from the description, or may be learned by practice of the invention. The objects and advantages are realized and attained by means of the instrumentalities and combinations particularly pointed out in the appended claims.

### BRIEF SUMMARY OF THE INVENTION

To achieve these and other objects, the present invention provides a collapsible protective shield assembly for a grass and weed trimmer wherein the trimmer includes an elongated shaft with a cutter head attached at a first end of the shaft and a handle attached to the shaft, the shield assembly including a clamping assembly for attaching the shield assembly to the shaft; first and second arms rotatably connected to the clamping assembly; and a flexible shield attached to the arms.

It is to be understood that both the foregoing general description and the following detailed description are exemplary and explanatory but are not restrictive of the invention.

### BRIEF DESCRIPTION OF THE SEVERAL VIEWS OF THE DRAWINGS

The accompanying drawings, which are incorporated in and constitute a part of the specification, illustrate a preferred embodiment of the invention and, together with the description, serve to explain the principles of the invention.

FIG. 1 is a perspective view of the collapsible protective shield assembly of this invention attached to a conventional grass and weed trimmer and wherein the shield assembly is shown in its fully open configuration;

FIG. 2 is a perspective view of the shield assembly of this invention attached to a conventional grass and weed trimmer and showing the shield assembly adjusted in position to allow the trimmer to get into hard to reach and confined places;

FIG. 3 is a perspective view of the shield assembly of this invention attached to a conventional grass and weed trimmer and showing the shield assembly collapsed into a compact configuration for easy storage;

FIG. 4 is a top plan view showing the mounting bracket or first support member 1, the second member or uni-fit spacer 2, and the threaded studs 3, 3′;

FIG. 5 is a front elevation view showing the elements illustrated in FIG. 4 and further showing the U-bolt 4 and fastening members or lock nuts 5, 5′ as they are positioned when the shield assembly is attached to the grass and weed trimmer, the trimmer not being shown in FIG. 5;

FIG. 6 is a top plan view showing one arm element 6′;

FIG. 7 is an elevation view showing arm element 6′;

FIG. 8 is an end view showing arm element 6′;

FIG. 9 is a perspective view showing end cap-hinge member 10; and

FIG. 10 is an exploded perspective view showing the protective shield assembly 18.

### DETAILED DESCRIPTION OF THE INVENTION

With reference now to the drawings, wherein like reference characters designate like or corresponding parts throughout the several views, there is shown a protective shield assembly 18 for a conventional grass and weed trimmer 20. Trimmer 20 includes an elongated shaft 22 with a cutter head 24 attached at a first end 26 of shaft 22 and a handle 28 attached to shaft 22.

Shield assembly 18 includes a clamping assembly 30 for attaching shield assembly 18 to shaft 22.

Shield assembly 18 further includes first and second arm assemblies 32, 32′ rotatably connected to clamping assembly 30. Shield assembly 18 further includes a flexible shield or guard 11 mounted on arm assemblies 32, 32′.

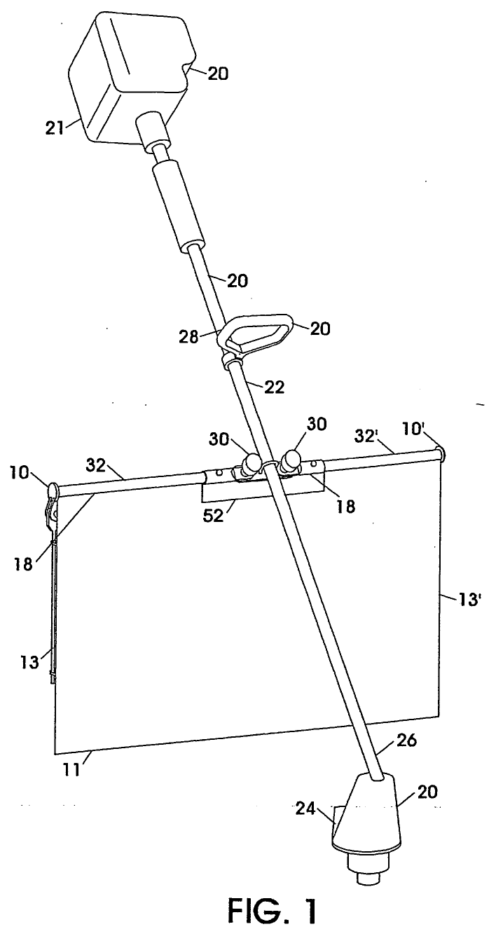

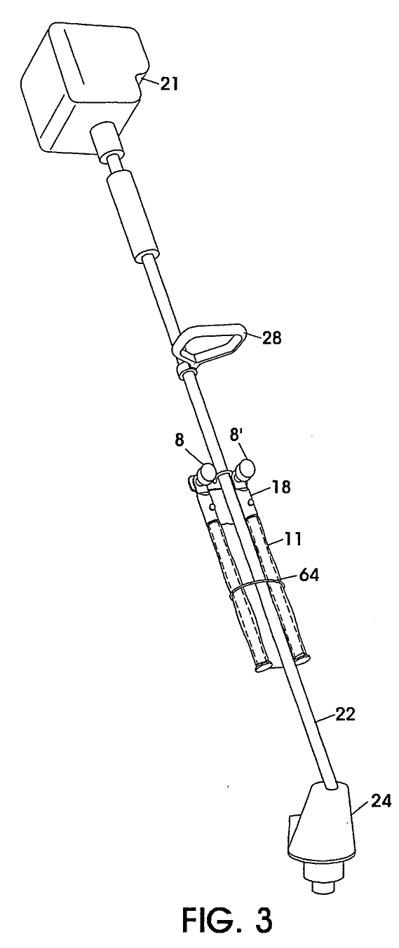

In accordance with the invention, arm assemblies 32, 32′ are rotatable between first positions substantially perpendicular to shaft 22 (FIG. 1) and second positions substantially parallel to shaft 22 (FIG. 3).

Further in accordance with the invention, flexible shield 11 is foldable in a secure and compact fashion beneath shaft 22 when arm assemblies 32, 32′ are positioned substantially parallel to shaft 22 (FIG. 3).

Shield assembly 18 further includes a shield securing assembly 12 attached to clamping assembly 30 for holding flexible shield 11 in place when shield 11 is folded beneath shaft 22.

Clamping assembly 30 includes a first support member or mounting bracket 1 defining first 34, second 34′ and third 36 openings therein.

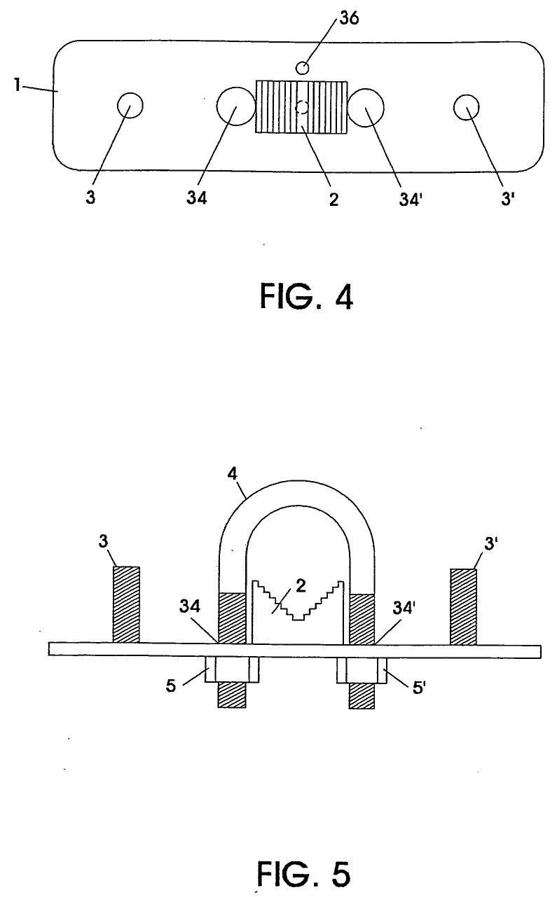

Clamping assembly 30 further includes a uni-fit spacer or second member 2 conventionally attached to first support member 1 between openings 34, 34′ (FIG. 4) for positioning against shaft 22 when clamping assembly 30 is attached to the shaft.

Clamping assembly 30 further includes a U-bolt 4 positioned through openings 34, 34′ against shaft 22 and in opposed relationship with uni-fit spacer or second member 2 when clamping assembly 30 is attached to shaft 22 (FIG. 5).

Clamping assembly 30 further includes first and second fastening members or lock nuts 5, 5′ removably attached to U-bolt 4 for holding shaft 22 between U-bolt 4 and second member 2 when clamping assembly 30 is attached to shaft 22.

First and second threaded stud members 3, 3′ are conventionally attached to and project upwardly from first support member 1 and are positioned outwardly from openings 34, 34′, respectively (FIGS. 4 and 5).

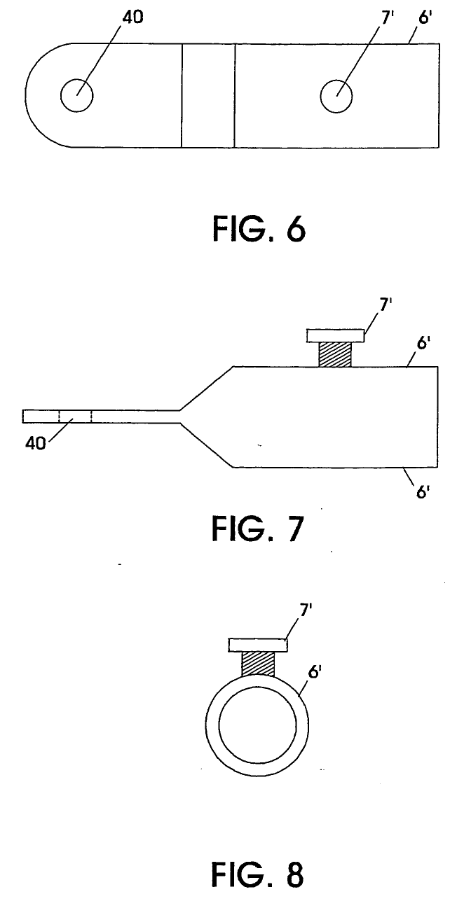

Arm assemblies 32, 32′ define fourth 38 and fifth 40 openings therein, respectively (FIGS. 6, 7 and 10).

Stud members 3, 3′ are positioned through openings 38, 40, respectively, whereby arm assemblies 32, 32′ can rotate about stud members 3, 3′.

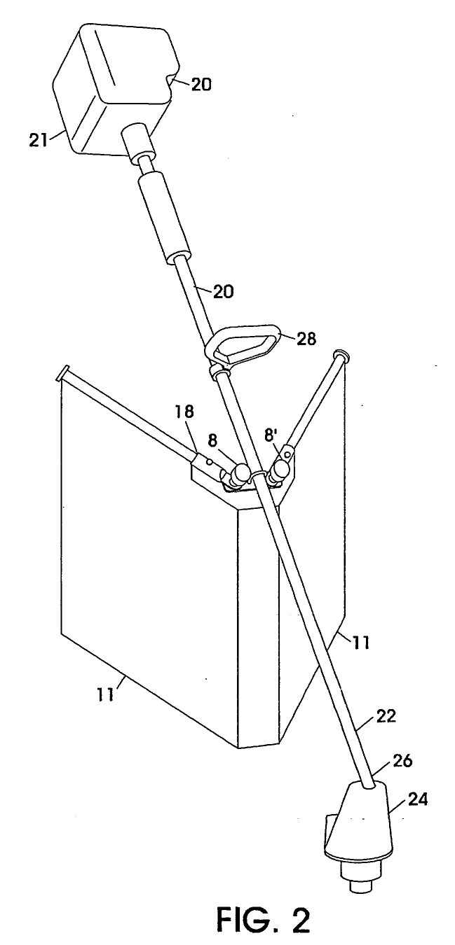

Further in accordance with the invention, shield assembly 18 includes threaded nuts 8, 8′ (FIGS. 2, 3 and 10) for threadably engaging stud members 3, 3′, respectively, and for selectively holding arm assemblies 32, 32′ in fixed positions when nuts 8, 8′ are tightened onto stud members 3, 3′ and against arm assemblies 32, 32′.

Arm assemblies 32, 32′ include first and second hollow and open-ended arm elements 6, 6′, respectively, defining openings 38, 40 therein, respectively, and having open ends 70, 70′, respectively. Tubular shield holders 9, 9′ (FIG. 10) are removably and slidably positioned within hollow arm elements 6, 6′, respectively. Tubular shield holders 9, 9′ are preferably hollow and define open ends 72, 72′, respectively.

Arm assemblies 32, 32′ further include means 7, 7′, such as machine screws, in operative relationship with arm elements 6, 6′ and with shield holders 9, 9′ for selectively holding shield holders 9, 9′ in fixed position with respect to arm elements 6, 6′.

Flexible shield or guard 11 is supported by and suspended from shield holders 9, 9′ during normal use of trimmer 20 and shield assembly 18.

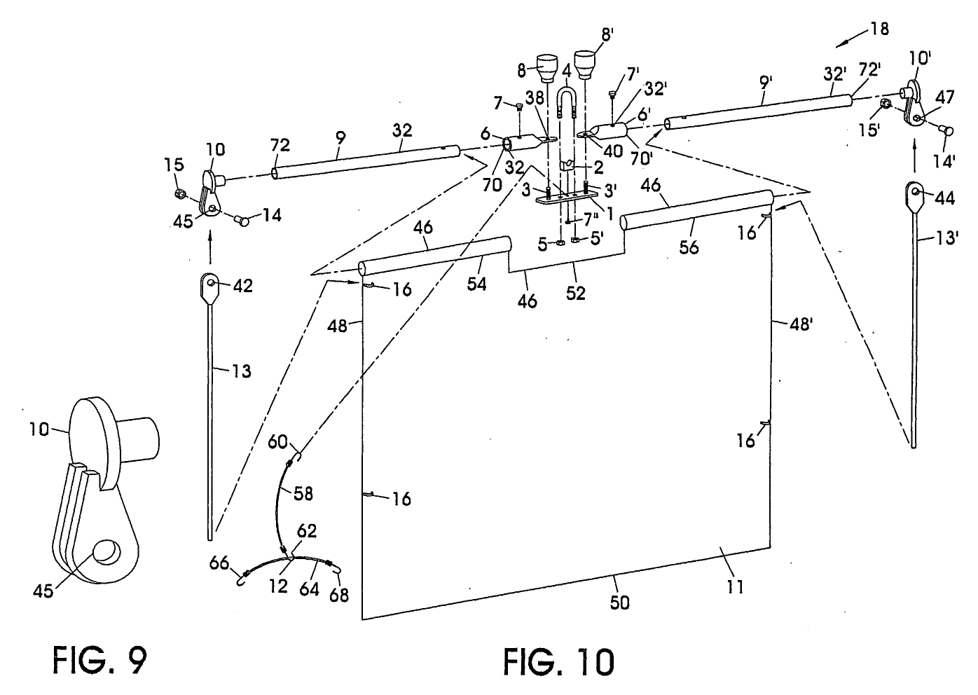

Shield assembly 18 further includes first and second flanged end cap-hinge members 10, 10′ (FIGS. 9 and 10) removably and slidably positioned within the open ends of shield holders 9, 9′, respectively, for keeping flexible shield 11 in place on shield holders 9, 9′ and for enabling shield 11 to be foldable in a compact fashion beneath shaft 22.

Shield assembly 18 further includes flexible loops 16 (FIG. 10) conventionally attached to flexible shield 11 adjacent to side edges 48, 48′. First and second flexible support rods 13, 13′ defining sixth and seventh openings 42, 44 therein, respectively, are positioned through respective ones of loops 16 with openings 42, 44 positioned for fastening rods 13, 13′ to end cap-hinge members 10, 10′, respectively. Fastening elements, such as bolts 14, 14′ and lock nuts 15, 15′, (FIG. 10) are provided for fastening support rods 13, 13′ to end cap-hinge members 10, 10′, respectively. Bolts 14, 14′ are positioned through openings 45, 47, respectively, in end cap-hinge members 10, 10′ and through openings 42, 44, respectively, in rods 13, 13′. Nuts 15, 15′ are tightened onto bolts 14, 14′, respectively.

Flexible shield 11 preferably defines a substantially rectangular shape having a top edge 46, two opposed side edges 48, 48′ and a bottom edge 50. Top edge 46 defines a substantially U-shaped cut out 52 and hollow tubular sleeves 54, 56 for slidably receiving tubular shield holders 9, 9′ therein, respectively.

Shield securing assembly 12 includes a first securing strap 58 having first and second hooked ends 60, 62, and first end 60 is positioned through third opening 36 in first support member or mounting bracket 1.

Shield securing assembly 12 further includes a second securing strap 64 having first and second ends 66, 68 for removable connection to each other, second securing strap 64 being connected to second end 62 of first securing strap 58 for enabling second securing strap 64 to be selectively positioned around flexible shield 11 and shaft 22 to hold shield 11 in a secure and compact position when shield 11 is folded beneath shaft 22.

In operation and use, shield assembly 18 is mounted on trimmer shaft 22 a sufficient distance away from trimmer cutting head 24 to allow for unobstructed operation of trimmer 20.

To prepare shield assembly 18 for use from the position shown in FIG. 3, hooked ends 66, 68 of second securing strap 64 are disconnected from each other. Threaded nuts 8, 8′ are then loosened on threaded studs 3, 3′ and arm assemblies 32, 32′ are moved to substantially perpendicular positions with respect to shaft 22 by rotating arm assemblies about studs 3, 3′. Nuts 8, 8′ are then tightened onto threaded studs 3, 3′ to hold arm assemblies 32, 32′ in fixed positions.

Flexible support rods 13, 13′ are then moved from positions substantially parallel with respect to arm assemblies 32, 32′ to positions substantially perpendicular to arm assemblies 32, 32′. This is accomplished by rotating support rods 13, 13′ about bolts 14, 14′ and with respect to end cap-hinge members 10, 10′, respectively.

The series of steps just described will result in shield assembly 18 moving from a position shown in FIG. 3 to a position shown in FIG. 1.

If it is desired to use trimmer 20 and shield assembly 18 in a confined space, nuts 8, 8′ are loosened on studs 3, 3′ and arm assemblies 32, 32′ are repositioned by rotating the arm assemblies about studs 3, 3′ until the desired position of shield 11 is attained. Nuts 8, 8′ are then retightened onto studs 3, 3′, and assembly 18 is positioned as shown, for example, in FIG. 2.

Arm assemblies 32, 32′ can be rotated about studs 3, 3′ in directions toward handle 28 until arm assemblies 32, 32′ are positioned substantially parallel with respect to trimmer shaft 22. Thus, the configuration of shield 11 can be quickly and easily changed from a position providing maximum shielding area as shown in FIG. 1, to a position previously described wherein arm assemblies 32, 32′ are rotated toward handle 28, and to all positions in between to enable shield 11 to be positioned for use in a variety of different size confined areas.

To close shield assembly 18, nuts 8, 8′ are loosened on studs 3, 3′. Support rods 13, 13′ are then repositioned substantially parallel to arm assemblies 32, 32′, respectively, by rotating support rods 13, 13′ with respect to end cap-hinge members 10, 10′, respectively.

Arm assemblies 32, 32′ are then rotated about studs 3, 3′ and toward cutter head 24 until arm assemblies 32, 32′ are positioned substantially parallel with respect to trimmer shaft 22.

Flexible shield 11 is then folded in a tight and compact manner to fit underneath shaft 22 and arm assemblies 32, 32′. Securing strap 64 of shield securing assembly 12 is then positioned around folded shield 11, shaft 22 and arm assemblies 32, 32′. Securing strap 64 is then fastened in place by connecting hooked ends 66, 68 together. Assembly 18 is then in the position for storage shown in FIG. 3.

This invention thus provides for an adjustable and collapsible protective shield assembly for use with conventional grass and weed trimmers which enables the trimmer to be used in compact and hard to reach places. The shield assembly can be quickly and easily folded into a compact position for easy storage.

The invention in its broader aspects is not limited to the specific details shown and described, and departures may be made from such details without departing from the principles of the invention and without sacrificing its chief advantages.

What is claimed is:

1. A protective shield assembly for a grass and weed trimmer, the trimmer including an elongated shaft with a cutter head attached at a first end of the shaft and a handle attached to the shaft, said shield assembly comprising:
a clamping assembly for attaching said shield assembly to said shaft;
first and second arm assemblies rotatably connected to said clamping assembly and positioned on opposite sides of said shaft from each other; and
a flexible shield mounted on said arm assemblies.

2. A shield assembly as in claim 1 wherein said arm assemblies are rotatable between first positions substantially perpendicular to said shaft and second positions substantially parallel to said shaft.

3. A shield assembly as in claim 2 wherein said flexible shield is foldable in a compact fashion beneath said shaft when said arm assemblies are positioned substantially parallel to said shaft.

4. A shield assembly as in claim 3 including a shield securing assembly attached to said clamping assembly for holding said flexible shield in place when said shield is folded beneath said shaft.

5. A shield assembly as in claim 4 wherein said clamping assembly includes:
a first support member defining first, second and third openings therein;
a second member attached to said first support member between said first and second openings for positioning against said shaft when said clamping assembly is attached to said shaft;
a U-bolt positioned through said first and second openings, against said shaft and in opposed relationship with said second member when said clamping assembly is attached to said shaft; and
first and second fastening members attached to said U-bolt for holding said shaft between said U-bolt and said second member when said clamping assembly is attached to said shaft.

6. A shield assembly as in claim 5 further including first and second stud members attached to said first support member and positioned outwardly from said first and second openings, respectively.

7. A shield assembly as in claim 6 wherein said first and second arm assemblies define fourth and fifth openings therein, respectively

8. A shield assembly as in claim 7 wherein said first and second stud members are positioned through said fourth and fifth openings, respectively, whereby said first and second arm assemblies can rotate about said first and second stud members.

9. A shield assembly as in claim 8 wherein said stud members are threaded and wherein said shield assembly further includes first and second threaded nuts for threadably engaging said first and second stud members, respectively, and for selectively holding said arm assemblies in fixed positions when said nuts are tightened onto said stud members and against said arm assemblies.

10. A shield assembly as in claim 9 wherein said first and second arm assemblies include:
first and second open-ended, hollow arm elements, respectively, defining said fourth and fifth openings therein, respectively;
first and second tubular, open-ended shield holders removably and slidably positioned within said first and second hollow arm elements, respectively; and
means in operative relationship with said arm elements and with said shield holders for selectively holding said shield holders in fixed position with respect to said arm elements.

11. A shield assembly as in claim 10 wherein said flexible shield is supported by and suspended from said shield holders during normal use of said trimmer and said shield assembly.

12. A shield assembly as in claim 11 further including first and second flanged end cap-hinge members removably and slidably positioned within said first and second shield holders respectively, for keeping said flexible shield in place on said shield holders.

13. A shield assembly as in claim 12 further including:
loops attached to said flexible shield;
first and second support rods defining sixth and seventh openings therein, respectively, and positioned through said loops with said sixth and seventh openings positioned for fastening said rods to said end cap-hinge members; and
fastening elements fastening said first and second support rods to said first and second en cap-hinge members, respectively.

14. A shield assembly as in claim 13 wherein said flexible shield defines a substantially rectangular shape having a top edge, two side edges and a bottom edge, said top edge defining a substantially U-shaped cutout and first and second hollow tubular sleeves for slidably receiving said first and second tubular shield holders therein, respectively.

15. A shield assembly as in claim 14 wherein said loops are positioned adjacent to said side edges of said flexible shield.

16. A shield assembly as in claim 4 wherein said shield securing assembly includes:
a first securing strap having first and second hooked ends, said first end being positioned through said third opening in said first support member; and
a second securing strap having first and second ends for removable connection to each other, said second securing strap being connected to said second end of said first securing strap for enabling said second securing strap to be selectively positioned around said flexible shield and said shaft to hold said flexible shield in secure position when said flexible shield is folded beneath said shaft.

17. The combination of a grass and weed trimmer and a protective shield assembly attached to the trimmer for protecting the operator from grass and debris, the combination comprising:
a grass and weed trimmer having an elongated shaft with a cutter head attached to a first end of said shaft;
a motor attached to said shaft in operative relationship with said cutter head for operating said cutter head;
a handle attached to said shaft;
a clamping assembly attached to said shaft between said handle and said cutter head;
first and second arms rotatably connected to said clamping assembly and positioned on opposite sides of said shaft from each other wherein said arms are rotatable between first positions substantially perpendicular to said shaft and second positions substantially parallel to said shaft; and
a flexible shield mounted on said arms wherein said flexible shield is foldable in a compact fashion beneath said shaft when said arms are positioned substantially parallel to said shaft.

18. The combination of claim 17 including a shield securing assembly attached to said clamping assembly for holding said flexible shield in place when said shield is folded beneath said shaft.
